(19) United States
(12) Patent Application Publication
(10) Pub. No.: US 2026/0096568 A1
(43) Pub. Date: Apr. 9, 2026

(54) A POST-HARVEST SOLUTION FOR AGRICULTURAL PRODUCE

(71) Applicant: Decco Worldwide Post Harvest Holding BV, Rotterdam (NL)

(72) Inventor: Jeanine Hordijk, Rotterdam (NL)

(73) Assignee: Decco Worldwide Post Harvest Holding BV, Rotterdam (NL)

(21) Appl. No.: 19/115,848

(22) PCT Filed: Sep. 22, 2023
(86) PCT No.: PCT/IB2023/059400

§ 371 Date: Mar. 27, 2025

(30) Foreign Application Priority Data
Sep. 29, 2022 (IN) 202211055970

(51) Int. Cl. A23B 7/154; A23B 2/75; A23B 2/771

(52) U.S. Cl. CPC A23B 7/154; A23B 2/75; A23B 2/771

(57) ABSTRACT

The present invention relates to a combination, a composition, and an application method thereof for preventing or decreasing post-harvest spoilage or decay and extending shelf life of agricultural produce. The present invention provides a method of preventing or decreasing post-harvest spoilage or decay and extending shelf-life of an agricultural produce by applying a combination comprising cinnamaldehyde and a fungicidal active, or a composition comprising said combination.

### TECHNICAL FIELD

The present invention relates to a combination, a composition and an application method thereof for preventing or decreasing post-harvest spoilage or decay and extending shelf life of agricultural produce. Particularly, the present invention relates to a method of preventing or decreasing post-harvest spoilage or decay and extending shelf-life of an agricultural produce by applying a combination comprising cinnamaldehyde and a fungicidal active or a composition comprising said combination.

### BACKGROUND

Post-harvest loss is a plaguing problem in any agricultural and food industry. Post-harvest loss includes the food loss across the food supply chain from harvesting of crop until its consumption. The losses can broadly be categorized as weight loss due to spoilage, quality loss, nutritional loss, seed viability loss, and commercial loss. Fruits and vegetables are among the most perishable agricultural produce. Generally, about 30-45% fruits and vegetables are rendered unfit for consumption due to spoilage after harvesting. A significant portion of losses of fruits and vegetables during post-harvest period is attributed to diseases caused by fungi and bacteria. The most common pathogens causing rots in vegetables and fruits are fungi such as Alternaria, Botrytis, Diplodia, Monilinia, Phomopsis, Rhizopus, Penicillium, Fusarium, etc.

Citrus fruits are a group of fruits widely planted and consumed worldwide, which have significant impacts on human health. Citrus fruits are of great significance to human health due to their functions and vitamin content. Post-harvest decay is the most serious cause of post-harvest loss of citrus in the world. Green mold and blue mold caused by Penicillium digitatum and Penicillium italicum are two main types of post-harvest decay of citrus, usually causing 90% of the total loss. Although post-harvest handlings, like avoiding mechanical damage during harvest and transportation and maintaining good storage and transportation conditions, can effectively reduce post-harvest decay of citrus, a lack of supporting facilities in the cultivation fields, like high-cost refrigeration storage and optimum transportation system, makes the chemical fungicides approach as an efficient and cheap first port of call by fruit farmers. However, emergence of resistant fungal populations towards chemical fungicides such as thiabendazole, imazalil, and sodium o-phenylphenate are coupled with harm to the environment and human health. Hence there is an increasing demand for development of new, safe, and effective control methods for addressing the post-harvest spoilage problems. To address this growing problem, the search for new control methods of citrus post-harvest phytopathogens is being extensively explored and the present invention proposes to solve this problem.

Similarly, stone fruits experience transit rot that usually develops in boxed fruit during transport. The numerous fungal pathogens that infect stone fruits after harvest including Rhizopus nigricans, Mucor spp., Botrytis cinerea, Geotrichum candidum, Alternaria spp, Aspergillus spp., Penicillium spp. and Monilinia spp. Although a large number of studies have demonstrated the efficacy of alternative postharvest treatments, only few of them are currently applied under commercial conditions. Some others, although developed and intended for near future commercial application, have limitations such as economic cost, delays due to registration issues, or reduced efficacy compared to conventional fungicides. Research is needed to resolve these obstacles to make all these strategies available in a near future.

Most of the alternative methods for post-harvest spoilage control have some limitations in comparison with conventional fungicides, and for this reason the inventors of the present invention have focused on the enhancement of the efficacy of the postharvest alternative treatments by the combination of two or more of them.

Considering the above unsolved problems, it is an object of the present invention to provide a new and effective solution for preventing or decreasing post-harvest spoilage by fungal pathogens and increasing the post-harvest shelf life of an agricultural produce.

It is another object of the present invention to provide a safer solution for preventing or decreasing post-harvest spoilage by fungal pathogens and increasing the post-harvest shelf life of an agricultural produce.

It is yet another object of the present invention to provide an effective fungicidal combination or a composition comprising said combination for preventing or decreasing post-harvest spoilage by fungal pathogens and increasing the post-harvest shelf life of an agricultural produce.

It is also an object of the present invention to provide a method of preventing or decreasing post-harvest spoilage of citrus fruits by green and blue mold and increase shelf-life of the fruits.

### SUMMARY

In an aspect, the present invention provides a method of improving post-harvest shelf-life of an agricultural produce, the method comprising contacting the agricultural produce with a combination comprising cinnamaldehyde and fludioxonil. In an aspect, said method comprises comprises preventing or decreasing post-harvest decay or spoilage of said agricultural produce.

In an aspect, the present invention provides a method of preventing or decreasing post-harvest decay and improving post-harvest shelf-life of an agricultural produce, the method comprising contacting the agricultural produce with a combination comprising cinnamaldehyde and fludioxonil.

In an aspect, the present invention provides a method of preventing or decreasing post-harvest decay and improving post-harvest shelf-life of an agricultural produce, the method comprising contacting the agricultural produce with a composition comprising cinnamaldehyde and fludioxonil.

In an aspect, the present invention provides a method of preventing or decreasing post-harvest decay or spoilage and improving post-harvest shelf-life of an agricultural produce, said method comprising contacting the agricultural produce with a combination comprising cinnamaldehyde and fludioxonil, or a composition comprising said combination.

In an aspect, the present invention provides a combination comprising cinnamaldehyde and fludioxonil for preventing or decreasing post-harvest decay and improving post-harvest shelf-life of an agricultural produce. In an embodiment, the said combination may be synergistic.

In an aspect, the present invention provides a composition comprising cinnamaldehyde and fludioxonil for preventing or decreasing post-harvest decay and improving post-harvest shelf-life of an agricultural produce.

In an aspect, the present invention provides a composition comprising a combination of cinnamaldehyde and fludioxonil for preventing or decreasing post-harvest decay and improving post-harvest shelf-life of an agricultural produce.

In another aspect, the present invention provides a method of applying a combination comprising cinnamaldehyde and fludioxonil post-harvest to an agricultural produce for preventing or decreasing post-harvest decay and improving post-harvest shelf-life of the agricultural produce.

In another aspect, the present invention provides a method of applying a composition comprising cinnamaldehyde and fludioxonil post-harvest to an agricultural produce for preventing or decreasing post-harvest decay and improving post-harvest shelf-life of the agricultural produce.

In an aspect, the present invention provides the use of a combination comprising cinnamaldehyde and fludioxonil or a composition comprising said combination for preventing or decreasing post-harvest decay or spoilage and improving post-harvest shelf-life of an agricultural produce.

In an aspect, the present invention provides the use of a composition comprising cinnamaldehyde and fludioxonil for preventing or decreasing post-harvest decay or spoilage and improving post-harvest shelf-life of an agricultural produce.

In yet another aspect, the present invention provides a kit-of-parts comprising a first component comprising cinnamaldehyde and a second component comprising fludioxonil.

In an additional aspect, the present invention provides a kit-of-parts comprising a first component comprising cinnamaldehyde, a second component comprising fludioxonil and optionally, a third component comprising one or more agriculturally suitable excipients.

### DETAILED DESCRIPTION

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of materials/ingredients used in the specification are to be understood as being modified in all instances by the term “about”.

As used herein, the term “about” refers to a measurable value such as a parameter, an amount, a temporal duration, and the like and is meant to include variations of +1-15% or less, specifically variations of +/−10% or less, more specifically variations of +1-5% or less, even more specifically variations of +/−1% or less, and still more specifically variations of +/−0.1% or less of and from the particularly recited value, in so far as such variations are appropriate to perform in the disclosure described herein. Furthermore, it is also to be understood that the value to which the modifier “about” refers is itself specifically disclosed herein.

Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth. All methods described herein can be performed in a suitable order unless otherwise indicated herein or otherwise clearly contradicted by context.

Thus, before describing the present invention in detail, it is to be understood that this invention is not limited to particularly exemplified process parameters or composition that may of course, vary. It is also to be understood that the terminology used herein is for the purpose of describing embodiments of the invention only and is not intended to limit the scope of the invention in any manner. The use of examples anywhere in this specification including examples of any terms discussed herein is illustrative only, and in no way limits the scope and meaning of the invention or of any exemplified term. Likewise, the invention is not limited to various embodiments given in this specification. Unless otherwise defined, all technical and scientific terms used herein have the same meaning as commonly understood by one of ordinary skill in the art to which this invention pertains. In the case of conflict, the present document, including definitions will control.

It must be noted that, as used in this specification, the singular forms “a,” “an” and “the” include plural referents unless the content clearly dictates otherwise. The terms “preferred” and “preferably” refer to embodiments of the invention that may afford certain benefits, under certain circumstances.

As used herein, the terms “comprising” “including,” “having,” “containing,” “involving,” and the like are to be understood to be open-ended, i.e., to mean including but not limited to.

The terms “g ai/L” or “gai/L” as used herein denotes the concentration of the respective active ingredient in “grams” present “per litre” of the composition.

As used herein, the term “cinnamaldehyde” refers to cinnamon oil, cinnamon extract or more specifically to cinnamaldehyde or cinnamic aldehyde, obtained naturally or via synthetic process. Cinnamaldehyde is the major component of cinnamon extract. According to the literature, more than 80% of the cinnamon extract is composed of this natural aldehyde, the rest of the components being, in a much more minor way, thymol, eugenol and others. Therefore, this extract can preferably be used to obtain the combination of the present invention. However, it is also preferable to use cinnamaldehyde obtained by synthesis since it facilitates its formulation and is available widely.

In an embodiment, the present invention provides a method of improving post-harvest shelf-life of an agricultural produce, the method comprising contacting the agricultural produce with a combination comprising cinnamaldehyde and fludioxonil.

In an embodiment, said method comprises preventing or decreasing post-harvest decay or spoilage of said agricultural produce.

In an embodiment of the present invention, there is provided a method of preventing or decreasing post-harvest decay or spoilage and improving post-harvest shelf-life of an agricultural produce, said method comprising contacting the agricultural produce with a combination comprising cinnamaldehyde and fludioxonil.

In an embodiment of the present invention, there is provided a method of preventing or decreasing post-harvest decay or spoilage and improving post-harvest shelf-life of an agricultural produce, the method comprising contacting the agricultural produce with a composition comprising a combination of cinnamaldehyde and fludioxonil.

In an embodiment of the present invention, there is provided a method of preventing or decreasing post-harvest decay or spoilage and improving post-harvest shelf-life of an agricultural produce, said method comprising contacting the agricultural produce with a combination comprising cinnamaldehyde and fludioxonil, or a composition comprising said combination.

In an embodiment, the post-harvest decay or spoilage is caused by fungus and/or bacteria.

In a preferred embodiment, the post-harvest decay or spoilage is caused by fungal or bacterial pathogens.

In a preferred embodiment, the post-harvest decay or spoilage is caused by fungus.

In an embodiment, the fungus causing post-harvest decay or spoilage belongs to Penicillium spp., Geotrichum spp., Botrytis spp., Diplodia spp., Phomopsis spp., Alternaria spp., Fusarium spp., Trichoderma spp., Phytophthora spp., Monilia spp., Rhizopus spp., Aspergillus spp., Geotrichum spp., Colletotrichum spp., Rhizoctonia spp., Sclerotium spp., Sclerotinia spp., and combinations thereof.

In a preferred embodiment, the fungus causing post-harvest decay or spoilage belongs to Penicillium genus.

In a preferred embodiment, the fungus causing post-harvest decay or spoilage is Penicillium digitatum, Penicillium italicum, or a combination thereof.

In a preferred embodiment, the fungus causing post-harvest decay or spoilage is Penicillium digitatum.

In a preferred embodiment, the fungus causing post-harvest decay or spoilage is Penicillium italicum.

In an embodiment, the agricultural produce is selected from crops, cereals, legumes, fruits, vegetables and cut flowers.

Examples of the crops on which the present compositions may be used include but are not limited to corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as strawberry, blueberry, cranberry, blackberry, raspberry, etc., grape, kaki fruit, olive, plum, banana, coffee, date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

In a preferred embodiment, the agricultural produce is fruits and/or vegetables.

Preferably, the agricultural produce is selected from the group consisting of citrus fruits; stone fruits such as peaches, nectarines, plums, cherries, apricots, mangoes, lychees, olives, dates, prunes; berries such as blueberries, cranberries, gooseberries, raspberries, blackberries, currants; melons, watermelons, pomegranates, kiwis, strawberries, grapes, papayas, apples, pears, bananas, avocados, zucchini, chickpeas, pumpkins, peppers, tomatoes, eggplants, gourds, corn, squash, okra, peas, beans, potatoes, celery, carrots, broccoli, cabbage, brussel sprouts, spinach and other leafy vegetables, lettuce, cucumbers, and herbs.

In a preferred embodiment, the agricultural produce is a citrus fruit, or a stone fruit.

In a preferred embodiment, the agricultural produce is a citrus fruit.

In an embodiment, the citrus fruit is selected from orange, tangerine, lemon, lime, grapefruit, tangel, mandarin, kumquat, pomelo, tangor, kinnow, tangelo, citron, bergamot, clementine, ugli, honeybell, satsuma, shaddock, yuzu, kanpei, haruka, kiyomi, lumia, pompia, and other hybrids.

In a preferred embodiment, the agricultural produce is a stone fruit. Examples of stone fruits include but are not limited to peaches, nectarines, plums, cherries, apricots, mangoes, lychees, olives, dates, and prunes.

In an embodiment of the present invention, there is provided a method of preventing or decreasing post-harvest decay or spoilage and improving post-harvest shelf-life of fruits and/or vegetables, the method comprising contacting the fruits and/or vegetables with a combination comprising cinnamaldehyde and fludioxonil or a composition comprising said combination.

In an embodiment of the present invention, there is provided a method of preventing or decreasing post-harvest decay or spoilage and improving post-harvest shelf-life of citrus fruit, the method comprising contacting the citrus fruit with a combination comprising cinnamaldehyde and fludioxonil or a composition comprising said combination.

In an embodiment of the present invention, there is provided a method of preventing or decreasing post-harvest decay or spoilage and improving post-harvest shelf-life of stone fruit, the method comprising contacting the stone fruit with a combination comprising cinnamaldehyde and fludioxonil or a composition comprising said combination.

In an embodiment of the present invention, there is provided a method of preventing or decreasing post-harvest decay or spoilage and improving post-harvest shelf-life of an agricultural produce by fungus, the method comprising contacting the agricultural produce with a combination comprising cinnamaldehyde and fludioxonil or a composition comprising said combination.

In an embodiment of the present invention, there is provided a method of preventing or decreasing post-harvest decay or spoilage and improving post-harvest shelf-life of citrus fruit by fungus, the method comprising contacting the citrus fruit with a combination comprising cinnamaldehyde and fludioxonil or a composition comprising said combination.

In an embodiment of the present invention, there is provided a method of preventing or decreasing post-harvest decay or spoilage and improving post-harvest shelf-life of stone fruit by fungus, the method comprising contacting the stone fruit with a combination comprising cinnamaldehyde and fludioxonil or a composition comprising said combination.

In an embodiment of the present invention, there is provided a method of preventing or decreasing post-harvest decay or spoilage and improving post-harvest shelf-life of an agricultural produce by Penicillium and/or Botrytis, the method comprising contacting the agricultural produce with a combination comprising cinnamaldehyde and fludioxonil or a composition comprising said combination.

In an embodiment of the present invention, there is provided a method of preventing or decreasing post-harvest decay or spoilage and improving post-harvest shelf-life of citrus fruit by Penicillium, the method comprising contacting the citrus fruit with a combination comprising cinnamaldehyde and fludioxonil or a composition comprising said combination.

In an embodiment of the present invention, there is provided a method of preventing or decreasing post-harvest decay or spoilage and improving post-harvest shelf-life of stone fruit by Botrytis, the method comprising contacting the stone fruit with a combination comprising cinnamaldehyde and fludioxonil or a composition comprising said combination.

In an embodiment of the present invention, there is provided a method of preventing or decreasing post-harvest decay or spoilage and improving post-harvest shelf-life of an agricultural produce by Penicillium digitatum, Penicillium italicum, Botrytis cinerea, or a combination thereof, the method comprising contacting the agricultural produce with a combination comprising cinnamaldehyde and fludioxonil or a composition comprising said combination.

In an embodiment of the present invention, there is provided a method of preventing or decreasing post-harvest decay or spoilage and improving post-harvest shelf-life of citrus fruit by Penicillium digitatum, Penicillium italicum, or a combination thereof, the method comprising contacting the citrus fruit with a combination comprising cinnamaldehyde and fludioxonil or a composition comprising said combination.

In an embodiment of the present invention, there is provided a method of preventing or decreasing post-harvest decay or spoilage and improving post-harvest shelf-life of stone fruit by Botrytis cinerea, or a combination thereof, the method comprising contacting the stone fruit with a combination comprising cinnamaldehyde and fludioxonil or a composition comprising said combination.

In an embodiment, said combination comprising cinnamaldehyde and fludioxonil is synergistic.

In an embodiment, the agricultural produce is contacted with the said combination or a composition comprising said combination after harvest.

In an embodiment, the agricultural produce is contacted with the said combination or a composition comprising said combination at post-harvest storage stage.

In an embodiment, the agricultural produce is treated with the said combination or a composition comprising said combination after harvest.

In an embodiment, the agricultural produce stays fresh longer when contacted with the said combination in post-harvest stage as compared to agricultural produce not contacted with the said combination. In an embodiment, the post-harvest vigor of the agricultural produce is increased when contacted with the said combination in post-harvest stage as compared to agricultural produce not contacted with the said combination. In an embodiment, the post-harvest shelf-life of the agricultural produce is increased when contacted with the said combination in post-harvest stage as compared to agricultural produce not contacted with the said combination. In an embodiment, post-harvest disease incidence and pest severity is reduced whereas disease control is increased when the said combination is applied in post-harvest stage as compared to agricultural produce not contacted with the said combination. In an embodiment, post-harvest disease incidence is prevented when the said combination is applied in post-harvest stage as compared to agricultural produce not contacted with the said combination. In an embodiment, said combination when applied to the agricultural produce can delay senescence, minimize spoilage, and improve appearance and marketability.

In an embodiment, cinnamaldehyde is applied at an application rate of about 1 to about 500 gai/L. In an embodiment, cinnamaldehyde is applied at an application rate of about 5 to about 500 gai/L. In an embodiment, cinnamaldehyde is applied at an application rate of about 50 to about 300 gai/L. In an embodiment, cinnamaldehyde is applied at an application rate of about 75 to about 200 gai/L. In an embodiment, cinnamaldehyde is applied at an application rate of about 100 to about 150 gai/L. In a preferred embodiment, cinnamaldehyde is applied at an application rate of about 1 to about 150 gai/L.

In an embodiment, fludioxonil is applied at an application rate of about 0.1 to about 200 gai/L. In an embodiment, fludioxonil is applied at an application rate of about 1 to about 200 gai/L. In an embodiment, fludioxonil is applied at an application rate of about 10 to about 150 gai/L. In an embodiment, fludioxonil is applied at an application rate of about 20 to about 100 gai/L. In an embodiment, fludioxonil is applied at an application rate of about 30 to about 90 gai/L. In an embodiment, fludioxonil is applied at an application rate of about 40 to about 80 gai/L. In an embodiment, fludioxonil is applied at an application rate of about 50 to about 70 gai/L. In a preferred embodiment, fludioxonil is applied at an application rate of about 0.1 to about 70 gai/L.

In an embodiment, the combination comprising cinnamaldehyde and fludioxonil may be applied as a premix, tank-mix or in a sequential manner. In sequential treatments, the treatment of cinnamaldehyde in a combination with fludioxonil may be carried out in immediate succession or staggered sequence or in regular intervals separated by definite time periods.

In an embodiment, the combination is applied as a tank-mix.

In an embodiment, cinnamaldehyde and fludioxonil or compositions comprising them may be applied simultaneously, that is jointly or separately, or in succession.

In an embodiment, there is provided a combination comprising cinnamaldehyde and fludioxonil.

In an embodiment, the combination may be useful for preventing or decreasing post-harvest decay or spoilage and improving post-harvest shelf-life of an agricultural produce.

In an embodiment, there is provided a combination comprising cinnamaldehyde and fludioxonil for preventing or decreasing post-harvest decay or spoilage and improving post-harvest shelf-life of an agricultural produce.

Said combination is for application, treatment or contacting with the agricultural produce after harvest or during post-harvest storage stage.

In an embodiment, cinnamaldehyde and fludioxonil are combined in a ratio of about 1:100 to about 100:1.

In an embodiment, cinnamaldehyde and fludioxonil are combined in a ratio of about 1:75 to about 75:1.

In an embodiment, cinnamaldehyde and fludioxonil are combined in a ratio of about 1:50 to about 50:1.

In an embodiment, cinnamaldehyde and fludioxonil are combined in a ratio of about 1:25 to about 25:1.

In an embodiment, cinnamaldehyde and fludioxonil are combined in a ratio of about 1:10 to about 10:1.

Preferably in an embodiment, cinnamaldehyde and fludioxonil are combined in a ratio of about 1:7 to about 7:1.

Preferably in an embodiment, cinnamaldehyde and fludioxonil are combined in a ratio of about 1:6.5 to about 6.5:1.

Preferably in an embodiment, cinnamaldehyde and fludioxonil are combined in a ratio of about 1:5 to about 5:1.

Preferably in an embodiment, cinnamaldehyde and fludioxonil are combined in a ratio of about 1:4 to about 4:1.

Preferably in an embodiment, cinnamaldehyde and fludioxonil are combined in a ratio of about 1:3.5 to about 3.5:1.

Preferably in an embodiment, cinnamaldehyde and fludioxonil are combined in a ratio of about 1:2 to about 2:1.

In an embodiment, there is provided a synergistic combination comprising cinnamaldehyde and fludioxonil.

In an embodiment, the combination may be useful for preventing or decreasing post-harvest decay or spoilage and improving post-harvest shelf-life of an agricultural produce.

In an embodiment, there is provided a synergistic combination comprising cinnamaldehyde and fludioxonil for preventing or decreasing post-harvest decay or spoilage and improving post-harvest shelf-life of an agricultural produce.

In an embodiment, said combination is a tank-mix of cinnamaldehyde and fludioxonil.

In an embodiment, said combination is a tank-mix of a composition comprising cinnamaldehyde and another composition comprising fludioxonil.

In an embodiment, the concentration of cinnamaldehyde in the composition ranges from 1%-99% w/w of total composition.

In an embodiment, the concentration of fludioxonil in the composition ranges from 1%-99% w/w of total composition.

In an embodiment, the composition comprising cinnamaldehyde further comprises an agrochemically suitable excipient.

In an embodiment, the composition comprising fludioxonil further comprises an agrochemically suitable excipient.

In an embodiment, there is provided a composition comprising cinnamaldehyde and fludioxonil for preventing or decreasing post-harvest decay or spoilage and improving post-harvest shelf-life of an agricultural produce.

In an embodiment, there is provided a composition comprising a synergistic combination of cinnamaldehyde and fludioxonil for preventing or decreasing post-harvest decay or spoilage and improving post-harvest shelf-life of an agricultural produce.

Said compositions are for application, treatment or contacting with the agricultural produce after harvest or during post-harvest storage stage.

In an embodiment, the concentration of cinnamaldehyde in the compositions of the present invention ranges from 1%-99% w/w of total composition.

In an embodiment, the concentration of fludioxonil in the compositions of the present invention ranges from 1%-99% w/w of total composition.

In an embodiment, the concentration of cinnamaldehyde in the compositions of the present invention ranges from 5%-80% w/w of total composition.

In an embodiment, the concentration of cinnamaldehyde in the compositions of the present invention ranges from 8%-60% w/w of total composition.

In an embodiment, the concentration of cinnamaldehyde in the compositions of the present invention ranges from 10%-70% w/w of total composition.

In an embodiment, the concentration of cinnamaldehyde in the compositions of the present invention ranges from 20%-40% w/w of total composition.

In an embodiment, the concentration of fludioxonil in the compositions of the present invention ranges from 5%-80% w/w of total composition.

In an embodiment, the concentration of fludioxonil in the compositions of the present invention ranges from 10%-70% w/w of total composition.

In an embodiment, the concentration of fludioxonil in the compositions of the present invention ranges from 13%-50% w/w of total composition.

In an embodiment, the concentration of fludioxonil in the compositions of the present invention ranges from 13%-30% w/w of total composition.

In an embodiment, the concentration of fludioxonil in the compositions of the present invention ranges from 17%-25% w/w of total composition.

In an embodiment, the concentration of cinnamaldehyde in the compositions of the present invention ranges from 0.1%-99% v/v of total composition.

In an embodiment, the concentration of cinnamaldehyde in the compositions of the present invention ranges from 0.1%-10% v/v of total composition.

In an embodiment, the concentration of cinnamaldehyde in the compositions of the present invention ranges from 0.1%-1% v/v of total composition.

In an embodiment, the concentration of fludioxonil in the compositions of the present invention ranges from 0.1%-99% v/v of total composition.

In an embodiment, the concentration of fludioxonil in the compositions of the present invention ranges from 0.1%-10% v/v of total composition.

In an embodiment, the concentration of fludioxonil in the compositions of the present invention ranges from 0.1%-1% v/v of total composition.

In an embodiment, the said composition may further comprise at least one agrochemically suitable excipient.

In an embodiment, the agriculturally suitable excipient is selected from any or a combination of wetting agent, dispersing agent, binding agent, surfactant/emulsifier, anti-freezing agent, mineral, filler, stabilizer, and preservative. However, it should be appreciated that any other agriculturally acceptable excipients, as known to a person skilled in the art, may be used to serve its intended purpose without departing from the scope of the present invention.

Exemplary preservatives that can be added to the compositions of the present invention may be selected from derivatives of benzoic acid, sorbic acid, formaldehyde, in particular potassium sorbate, a combination of methyl parahydroxybenzoate or propyl parahydroxybenzoate.

Exemplary antifreeze agent(s) added to the composition may be alcohols selected from the group comprising of but not limited to ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol, octaglycerol.

Examples of suitable surfactants are, but not limited to, alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, polyethylene glycol, furthermore condensates of sulfonated naphthalene and naphthalene derivatives with formaldehyde, condensates of naphthalene or of naphthalenesulfonic acid with phenol and formaldehyde, polyoxyethylene octylphenol ethers, ethoxylated isooctylphenol, octylphenol, nonylphenol, alkylphenol polyglycol ethers, tributylphenyl polyglycol ethers, tristearylphenyl polyglycol ethers, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Examples of nonionic surfactants include polyarylphenol polyethoxy ethers, polyalkylphenol polyethoxy ethers, polyglycol ether derivatives of saturated fatty acids, polyglycol ether derivatives of unsaturated fatty acids, polyglycol ether derivatives of aliphatic alcohols, polyglycol ether derivatives of cycloaliphatic alcohols, fatty acid esters of polyoxyethylene sorbitan, alkoxylated vegetable oils, alkoxylated acetylenic diols, polyalkoxylated alkylphenols, fatty acid alkoxylates, sorbitan alkoxylates, sorbitol esters, C₈-C₂₂ alkyl or alkenyl polyglycosides, polyalkoxy styrylaryl ethers, alkylamine oxides, block copolymer ethers, polyalkoxylated fatty glyceride, polyalkylene glycol ethers, linear aliphatic or aromatic polyesters, organo silicones, polyaryl phenols, sorbitol ester alkoxylates, polyalkylene oxide block copolymers, acrylic copolymers and mono- and diesters of ethylene glycol and mixtures thereof.

In another embodiment, the composition can be presented in solid form, especially in the form of powders, dusts or granules, water dispersible granules, microcapsules or wettable powders or in liquid form, for example, emulsifiable concentrates, solutions, emulsions or suspensions, ZC formulations, oil dispersions.

Thus, the present invention provides a composition for preventing or decreasing post-harvest decay or spoilage and improving post-harvest shelf-life of an agricultural produce comprising a combination comprising cinnamaldehyde and fludioxonil, and at least one agrochemically suitable excipient.

In an embodiment, the combinations and compositions of the present disclosure may further be combined with one or more other agrochemically active substances. The other agrochemically active substances may be selected from but not limited to herbicides, fungicides, insecticides, biologicals, bio-solutions, plant extracts, anti-sprout agents, and so forth. In an embodiment, the other agrochemically active substance is a fungicide.

In an embodiment, the other agrochemically active substance is a fungicide selected from but not limited to (3-ethoxypropyl)mercury bromide, 2-methoxyethylmercury chloride, 2-phenylphenol, 8-hydroxyquinoline sulfate, 8-phenylmercurioxyquinoline, acetate, acibenzolar, acypetacs, acypetacs-copper, acypetacs-zinc, albendazole, aldimorph, allicin, allyl alcohol, ametoctradin, aminopyrifen, amisulbrom, amobam, ampropylfos, anilazine, asomate, aureofungin, azaconazole, azithiram, azoxystrobin, barium polysulfide, basic copper carbonate, basic copper sulfate, benalaxyl, benalaxyl-M, benodanil, benomyl, benquinox, bentaluron, benthiavalicarb, benthiazole, benzalkonium chloride, benzamacril, benzamorf, benzohydroxamic acid, benzovindiflupyr, berberine, bethoxazin, bifujunzhi, binapacryl, biphenyl, bitertanol, bithionol, bixafen, blasticidin-S, Bordeaux mixture, boscalid, bromothalonil, bromuconazole, bupirimate, Burgundy mixture, buthiobate, butylamine, calcium polysulfide, captafol, captan, carbamorph, carbendazim, carbon disulfide, carboxin, carpropamid, carvacrol, carvone, Cheshunt mixture, chinomethionat, chitosan, chlobenthiazone, chloraniformethan, chloranil, chlorfenazole, chlorodinitronaphthalenes, chloroneb, chloropicrin, chlorothalonil, chlorquinox, chlozolinate, climbazole, clotrimazole, copper acetate, copper hydroxide, copper naphthenate, copper oleate, copper oxychloride, copper silicate, copper sulfate, copper zinc chromate, coumoxystrobin, cresol, cufraneb, cuprobam, cuprous oxide, cyanogen, cyazofamid, cyclafuramid, cycloheximide, cyflufenamid, cymoxanil, cypendazole, cyproconazole, cyprodinil, dazomet, DBCP, debacarb, decafentin, dehydroacetic acid, dichlobentiazox, dichlofluanid, dichlone, dichlorophen, dichlozoline, diclobutrazol, diclocymet, diclomezine, dicloran, diethofencarb, diethyl pyrocarbonate, difenoconazole, diflumetorim, dimefluazole, dimetachlone, dimethachlone, dimethirimol, dimethomorph, dimethyl disulfide, dimoxystrobin, diniconazole, diniconazole-M, dinobuton, dinocap, dinocap-4, dinocap-6, dinocton, dinopenton, dinosulfon, dinoterbon, diphenylamine, dipymetitrone, dipyrithione, disulfiram, ditalimfos, dithianon, DNOC, dodemorph, dodicin, dodine, drazoxolon, EBP, edifenphos, enoxastrobin, epoxiconazole, etaconazole, etem, ethaboxam, ethirimol, ethoxyquin, ethylicin, ethylmercury 2,3-dihydroxypropyl mercaptide, ethylmercury acetate, ethylmercury bromide, ethylmercury chloride, ethylmercury phosphate, etridiazole, extract from Melaleuca alternifolia, famoxadone, fenamidone, fenaminosulf, fenaminstrobin, fenapanil, fenarimol, fenazaquin, fenbuconazole, fenfuram, fenhexamid, fenitropan, fenjuntong, fenoxanil, fenpiclonil, fenpicoxamid, fenpropidin, fenpropimorph, fenpyrazamine, fentin, ferbam, ferimzone, florylpicoxamid, fluazinam, flubeneteram, fludioxonil, flufenoxystrobin, fluindapyr, flumetover, flumorph, fluopicolide, fluopimomide, fluopyram, fluoroimide, fluotrimazole, fluoxapiprolin, fluoxastrobin, fluquinconazole, flusilazole, flusulfamide, flutianil, flutolanil, flutriafol, fluxapyroxad, folpet, formaldehyde, fosetyl, fuberidazole, furalaxyl, furametpyr, furcarbanil, furconazole, furconazole-cis, furfural, furmecyclox, furophanate, geraniol, glyodin, griseofulvin, guazatine, halacrinate, hexachlorobenzene, hexachlorobutadiene, hexachlorophene, hexaconazole, hexylthiofos, huanjunzuo, hydrargaphen, hymexazol, hymexazole, imazalil, imibenconazole, iminoctadine, inezin, inpyrfluxam, iodocarb, ipconazole, ipfentrifluconazole, ipflufenoquin, iprobenfos, iprobenfos (IBP), iprodione, iprovalicarb, isofetamid, isoflucypram, isoprothiolane, isopyrazam, isotianil, isovaledione, izopamfos, jiaxiangjunzhi, kasugamycin, kejunlin, kresoxim-methyl, mancopper, mancozeb, mandestrobin, mandipropamid, maneb, mebenil, mecarbinzid, mefentrifluconazole, mepanipyrim, mepronil, meptyldinocap, mercuric chloride, mercuric oxide, mercurous chloride, metalaxyl, metalaxyl-M, metam, metazoxolon, metconazole, methasulfocarb, methfuroxam, methyl bromide, methyl iodide, methyl isothiocyanate, methylmercury benzoate, methylmercury dicyandiamide, methylmercury pentachlorophenoxide, metiram, metominostrobin, metrafenone, metsulfovax, metyltetraprole, milneb, moroxydine, myclobutanil, myclozolin, N-(ethylmercury)-p-toluenesulfonanilide, nabam, natamycin, ningnanmycin, nitrostyrene, nitrothal-isopropyl, nuarimol, OCH, octhilinone, ofurace, orysastrobin, osthol, oxadixyl, oxathiapiprolin, oxine-copper, oxolinic acid, oxpoconazole, oxycarboxin, oxyfenthiin, oxytetracycline, parinol, pefurazoate, penconazole, pencycuron, penflufen, pentachlorophenol, pentachlorophenyl laurate, penthiopyrad, phenamacril, phenylmercuriurea, phenylmercury acetate, phenylmercury chloride, phenylmercury derivative of pyrocatechol, phenylmercury nitrate, phenylmercury salicylate, phosdiphen, phthalide, picarbutrazox, picoxystrobin, piperalin, plant oils (mixtures): eugenol, polycarbamate, polyoxins, polyoxorim, polyoxorim-zinc, potassium azide, potassium polysulfide, potassium thiocyanate, probenazole, prochloraz, procymidone, propamidine, propamocarb, propiconazole, propineb, proquinazid, prothiocarb, prothioconazole, pydiflumetofen, pyracarbolid, pyraclostrobin, pyrametostrobin, pyraoxystrobin, pyrapropoyne, pyraziflumid, pyrazophos, pyribencarb, pyridachlometyl, pyridinitril, pyrifenox, pyrimethanil, pyriofenone, pyrisoxazole, pyroquilon, pyroxychlor, pyroxyfur, quinacetol, quinazamid, quinconazole, quinofumelin, quinoxyfen, quintozene, quintozene (PCNB), rabenzazole, saijunmao, saisentong, salicylanilide, sanguinarine, santonin, sedaxane, silthiofam, simeconazole, sodium azide, sodium pentachlorophenate, sodium polysulfide, sodium tetrathiocarbonate, sodium o-phenylphenoxide, spiroxamine, streptomycin, sulfur, sultropen, tebuconazole, tebufloquin, tecloftalam, tecnazene, tecnazene (TCNB), tecoram, tetraconazole, thiabendazole, thiadifluor, thicyofen, thifluzamide, thiochlorfenphim, thiocyanatodinitrobenzenes, thiodiazole-copper, thiomersal, thiophanate, thiophanate-methyl, thioquinox, thiram, tiadinil, tioxymid, tolclofos-methyl, tolfenpyrad, tolnifanide, tolprocarb, tolylfluanid, tolylmercury acetate, triadimefon, triadimenol, triamiphos, triarimol, triazbutil, triazoxide, tribasic copper sulphate, tributyltin oxide, trichlamide, trichlorotrinitrobenzenes, triclopyricarb, tricyclazole, tridemorph, trifloxystrobin, triflumizole, triforine, trimorphamide, triticonazole, uniconazole, uniconazole-P, urbacide, validamycin, valifenalate, vangard, vinclozolin, xinjunan, zarilamid, zinc naphthenate, zinc thiazole, zinc trichlorophenate, zineb, ziram, zoxamide.

In an embodiment, the other agrochemically active substance is a strobilurin fungicide selected from fluoxastrobin, mandestrobin, pyribencarb, azoxystrobin, coumoxystrobin, enoxastrobin, flufenoxystrobin, picoxystrobin, pyraoxystrobin, pyraclostrobin, pyrametostrobin, triclopyricarb, dimoxystrobin, fenaminstrobin, metominostrobin, orysastrobin, kresoxim-methyl, trifloxystrobin and combinations thereof.

In a preferred embodiment, the strobilurin fungicide is azoxystrobin or picoxystrobin or trifloxystrobin.

In an embodiment, the other agrochemically active substance is a plant growth regulator selected from but not limited to antiauxins, auxins, auxin transport inhibitors, cytokinins, defoliants, ethylene inhibitors, ethylene releasers, frost protectants, gametocides, gibberellins, growth inhibitors, growth retardants, growth stimulators, unclassified plant growth regulators, or combinations thereof.

In an embodiment, the other agrochemically active substance is a plant growth regulator selected from but not limited to 1-methylcyclopropene; 1-naphthol; 2,3,5-triiodobenzoic acid; 2,5-dichlorobenzoic acid; 2iP; 4-CPA; 4-hydroxyphenethyl alcohol; abscisic acid; ACC; ancymidol; anisiflupurin; aviglycine; bachmedesh; benzofluor; benzyladenine; buminafos; butralin; calcium cyanamide; carbaryl; carvone; chlorfluren; chlorflurenol; chlormequat; chlorphonium; chlorpropham; choline chloride; ciobutide; clofencet; clofibric acid; cloxyfonac; cyanamide; cyclanilide; cycloheximide; DA-6; daminozide; DCPTA; dichlorflurenol; dichlorprop; dikegulac; dimethipin; endothal; epocholeone; etacelasil; ethephon; ethychlozate; ethylene; fenoprop; fenridazon; flumetralin; fluoridamid; flurenol; flurprimidol; forchlorfenuron; fosamine; fuphenthiourea; furalane; gibberellic acid; gibberellins; glyoxime; glyphosine; heptamaloxyloglucan; heptopargil; holosulf; hymexazol; IAA; IBA; inabenfide; isopyrimol; jasmonic acid; karetazan; kinetin; lead arsenate; maleic hydrazide; maleic hydrazide; mefluidide; mepiquat; merphos; metoxuron; naphthaleneacetamide; naphthoxyacetic acids; orthonil; paclobutrazol; pentachlorophenol; piproctanyl; potassium naphthenate; prohexadione; prohydrojasmon; propham; psoralen; pydanon; pyripropanol; sintofen; sodium naphthenate; tetcyclacis; thidiazuron; tiaojiean; triacontanol; triapenthenol; tribufos; trinexapac; uniconazole; zeatin; α-naphthaleneacetic acids; or combinations thereof.

In an embodiment, the combination comprising cinnamaldehyde and fludioxonil may be combined with the other agrochemically active substance as a tank-mix combination at the time of application.

In an embodiment, the other agrochemically active substance may be applied before or after the application of the combination comprising cinnamaldehyde and fludioxonil.

In an embodiment, the composition comprising cinnamaldehyde and fludioxonil may further comprise the other agrochemically active substance.

In an embodiment, the composition comprising cinnamaldehyde and fludioxonil may be combined with the other agrochemically active substance as a tank mix.

In an embodiment, the combination comprising cinnamaldehyde and fludioxonil or a composition comprising the said combination is applied to the agricultural produce by any conventional means known to a person skilled in the art. Exemplary application methods include, but are not limited to, coating, drenching, dipping, spraying, fogging, sprinkling, fumigation, foliar application and so forth.

In an embodiment, there is provided a use of a combination comprising cinnamaldehyde and fludioxonil or a composition comprising said combination for preventing or decreasing post-harvest decay or spoilage and improving post-harvest shelf-life of an agricultural produce. In an embodiment, said combination is synergistic.

An embodiment of the present invention also provides a kit-of-parts comprising a first component comprising cinnamaldehyde and a second component comprising fludioxonil. In an embodiment, any one or both the components of the kit-of-parts may additionally comprise one or more agriculturally suitable excipients.

In another embodiment, the kit-of-parts may additionally comprise a third component comprising one or more agriculturally suitable excipients.

Thus, in an embodiment, there is provided a kit-of-parts comprising a first component comprising cinnamaldehyde, a second component comprising fludioxonil and optionally, a third component comprising one or more agriculturally suitable excipients.

In an embodiment, the kit-of-parts may comprise a set of instructions for mixing the individual components. In an embodiment, the individual components may be mixed with each other at the time of application or before use forming a resultant combination or a composition as described in the embodiments of the present invention.

Synergistic effect refers to efficacy greater than additive effect of individual efficacies of the constituent active ingredients, here cinnamaldehyde and fludioxonil. This effectiveness of all treatments can be evaluated according to Colby's equation. In the Colby's equation given below, E is the expected efficacy of combination of cinnamaldehyde and fludioxonil,
X is the observed efficacy of cinnamaldehyde and
Y is the observed efficacy of the herbicide of fludioxonil.

Observed efficacy values i.e. X and Y are % fungal spoilage control of agricultural produce for cinnamaldehyde and fludioxonil respectively. If observed efficacy of combination of cinnamaldehyde and fludioxonil is greater than its expected efficacy, then combination is determined to be synergistic. If observed efficacy is equal to or less than expected efficacy, then combination is determined to be non-synergistic.

$$Colby ’ s equation E = X + Y - X Y / 100$$

The results of synergistic effects of the present combinations/compositions is represented in examples. As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth.

The present invention will be further illustrated in the following examples. However, it is to be understood that these examples are for illustrative purposes only and should not be used to limit the scope of the present invention in any manner.

### EXAMPLES

### Example 1: Efficacy of Postharvest Dip Treatment of Cinnamaldehyde and Fludioxonil on Green Mould Penicillium digitatum on Citrus

Tandor mandarins were stored at 10° C., surface sterilized with a 150 ppm chlorine solution and treated 24 h after removal from the cold before commencing the trial. 4 replicates with thirty four fruit per replicate and 4 treatments were used in this trial. A haemacytometer was used to prepare a Penicillium digitatum spore concentration of 1×10⁶ spores/mL. Fruit was inoculated and incubated for 18 hours. Fruit was then treated with the various treatments as provided in Table 1 by dipping them for 60 seconds in the solution. Fludioxonil 230 SC and Cinnamaldehyde 300 SL were applied as solo treatments and Fludioxonil 230 SC in tank-mix combination with Cinnamaldehyde 300 SL was applied as dip treatment. An untreated control was included for comparison in the trial. Physio-chemical parameters were noted directly before and after each treatment was carried out.

### Assessments:

The fruit were carefully inspected for phytotoxicity symptoms, e.g. browning, necrotic tissue (ring burn), chlorotic tissue (mottling) and/or deformities at 7 DAA (Days After Application) and 17 DAA. Three efficacy assessments were conducted at 7 DAA (Days After Application) and 19DAA on 34 fruit/replicate. The results recorded for the trial are provided in Table 1.

TABLE 1
Efficacy of postharvest dip treatment of cinnamaldehyde and
fludioxonil on green mould Penicillium digitatum on citrus

| | Control | Expected efficacy | Control | Expected efficacy |
|---|---|---|---|---|
| | efficacy at | as per Colby | efficacy at | as per Colby |
| Treatment | 7 DAA (%) | calculation (%) | 19 DAA (%) | calculation (%) |
| Untreated control | 0 | — | 0 | — |
| Fludioxonil (60 gai/L) | 58.4 | — | 18.08 | — |
| Cinnamaldehyde | 30 | — | 0 | — |
| (120 gai/L) | | | | |
| Cinnamaldehyde | 92.1 | 70.88 | 61.6 | 18.08 |
| (120 gai/L) + | | | | |
| Fludioxonil (60 | | | | |
| gai/L) | | | | |

From the above example, it is evident that the combination of cinnamaldehyde and fludioxonil was synergistic over solo treatments and controlled post-harvest spoilage by Penicillium digitatum better than the solo treatments of fludioxonil or cinnamaldehyde.

### Example 2: Efficacy of Postharvest Dip Treatment of Cinnamaldehyde and Fludioxonil on Green Mould Penicillium digitatum on Citrus (Valencia Orange)

After harvest, a total of 840 Valencia Orange fruits (6 replicate sets) were treated and stored at 20° C. The trial commenced with a post-harvest dip application. Fludioxonil 230 SC was applied at 260 ml/100 L water, Cinnamaldehyde 300 SL at 400 ml/100 L water and Fludioxonil at 260 ml/100 L water in tank mixture with Cinnamaldehyde at 400 ml/100 L water. An untreated control was also included in this trial.

### Assessments:

Treatments were evaluated for any mixability problems with the water, adjuvant(s) and other combination compounds. The fruit were carefully inspected for phytotoxicity symptoms, e.g. browning, necrotic tissue (ring burn), chlorotic tissue (mottling) and/or deformities at 5 DAA (Days After Application), 7 DAA, and 10 DAA. Four efficacy assessments were conducted at 5 DAA, 7 DAA, 10 DAA by evaluating the green mould (Penicillium digitatum) on 20 fruits on both sides per replicate. Once fruit showed signs of decay it was removed. The results recorded for the trial are provided in Table 2.

TABLE 2
Efficacy of postharvest dip treatment of cinnamaldehyde and fludioxonil
on green mould Penicillium digitatum on citrus (Valencia Orange).

| | | Expected | | Expected | Control | Expected |
|---|---|---|---|---|---|---|
| | Control | efficacy as | Control | efficacy as | efficacy | efficacy as |
| | efficacy | per Colby | efficacy | per Colby | at 10 | per Colby |
| | at 5 DAA | calculation | at 7 DAA | calculation | DAA | calculation |
| Treatment | (%) | (%) | (%) | (%) | (%) | (%) |
| Untreated control | 0 | — | 0 | — | 0 | — |
| Fludioxonil (60 | 85 | — | 74 | — | 61 | — |
| gai/L) | | | | | | |
| Cinnamaldehyde | 10 | — | 0 | — | 0 | — |
| (120 gai/L) | | | | | | |
| Cinnamaldehyde | 100 | 86.5 | 90 | 74 | 74 | 61 |
| (120 gai/L) + | | | | | | |
| Fludioxonil (60 | | | | | | |
| gai/L) | | | | | | |

From the above example, it is evident that the combination of cinnamaldehyde and fludioxonil was synergistic over solo treatments and controlled post-harvest spoilage by Penicillium digitatum better than the solo treatments of fludioxonil or cinnamaldehyde.

### Example 3: Efficacy of Cinnamaldehyde and Fludioxonil on Botrytis cinerea on Stone Fruit (Plum)

Spore suspensions of Botrytis cinerea were prepared by growing the pathogens on Petri dishes for two weeks on potato dextrose agar added with 25 mg/L of streptomycin. After two weeks of incubation at 25° C., spores were collected and suspended in Tween solution. After filtering through eight layers of sterile cheese-cloth, spores were counted and brought to a final concentration of 5×10⁴ spores/ml.

All spore suspensions were kept at 4° C. and were used within 24 h of being harvested.

Ten stone fruit (plum) per box, ×3 replications were used to reproduce the most probable conditions after harvesting.

Plums were wounded once on the equator of the fruit with a probe tip (3 mm wide and 3 mm deep), and a micropipette was used to inoculate the fruits with 20 μL of a suspension of B. cinerea containing 5×10⁴ spores per ml. Inoculated fruits were held at room temperature for 18 to 24 h before application of the antifungal treatments for spore germination to occur within the wound sites to simulate infections that occur during harvest.

Inoculated fruits were emerged in the treatment baths for 60 sec before left to dry. Boxes were lined with moist paper towel and covered with a black plastic bag and incubated at ±25° C.

Fruits were evaluated 11 days post treatment and results recorded are provided in Table 3.

TABLE 3
Efficacy of cinnamaldehyde and fludioxonil
on Botrytis cinerea on stone fruit (plum).

| | | Control | Expected efficacy |
|---|---|---|---|
| | Dosage | efficacy at | as per Colby |
| Treatment | gai/L | 11 DAA (%) | calculation (%) |
| Untreated control | — | 0 | — |
| Fludioxonil (0.13%) | 0.3 | 13.33 | — |
| Cinnamaldehyde (0.4%) | 1.25 | 0 | — |
| Cinnamaldehyde (0.6%) | 1.87 | 0 | |
| Cinnamaldehyde (0.4%) + | 1.25 + 0.3 | 22.67 | 13.33 |
| Fludioxonil (0.13%) | | | |
| Cinnamaldehyde (0.6%) + | 1.87 + 0.3 | 50 | 13.33 |
| Fludioxonil (0.13%) | | | |

From the above example, it is evident that the combination of cinnamaldehyde and fludioxonil was synergistic over solo treatments and controlled post-harvest spoilage by Botrytis cinerea better than the solo treatments of fludioxonil or cinnamaldehyde.

1. A method of improving post-harvest shelf-life of an agricultural produce, said method comprising contacting the agricultural produce with a combination comprising cinnamaldehyde and fludioxonil, or a composition comprising said combination.

2. The method of claim 1, wherein said method comprises preventing or decreasing post-harvest decay or spoilage of said agricultural produce.

3. The method of claim 1, wherein said agricultural produce is contacted with said combination or a composition comprising said combination after harvest or at post-harvest storage stage.

4. The method of claim 1, wherein said agricultural produce is selected from crops, cereals, legumes, fruits, vegetables and cut flowers.

5. The method of claim 4, wherein said agricultural produce is fruits and/or vegetables selected from the group consisting of citrus fruits; peaches, nectarines, plums, cherries, apricots, mangoes, lychees, olives, dates, prunes, blueberries, cranberries, gooseberries, raspberries, blackberries, currants, melons, watermelons, pomegranates, kiwis, strawberries, grapes, papayas, apples, pears, bananas, avocados, zucchini, chickpeas, pumpkins, peppers, tomatoes, eggplants, gourds, corn, squash, okra, peas, beans, potatoes, celery, carrots, broccoli, cabbage, brussels sprouts, spinach, lettuce, cucumbers, and herbs.

6. The method of claim 1, wherein said post-harvest decay or spoilage is caused by fungus or bacteria.

7. The method of claim 6, wherein the fungus causing post-harvest decay or spoilage belongs to Penicillium spp., Geotrichum spp., Botrytis spp., Diplodia spp., Phomopsis spp., Alternaria spp., Fusarium spp., Trichoderma spp., Phytophthora spp., Monilia spp., Rhizopus spp., Aspergillus spp., Geotrichum spp., Colletotrichum spp., Rhizoctonia spp., Sclerotium spp., Sclerotinia spp., or a combinations thereof.

8. The method of claim 1, wherein cinnamaldehyde is applied at an application rate of about 1 to about 500 gai/L.

9. The method of claim 1, wherein fludioxonil is applied at an application rate of about 0.1 to about 200 gai/L.

10. The method of claim 1, wherein the combination comprising cinnamaldehyde and fludioxonil is applied as a premix, tank-mix or in a sequential manner.

11. A combination comprising cinnamaldehyde and fludioxonil for preventing or decreasing post-harvest decay or spoilage and improving post-harvest shelf-life of an agricultural produce.

12. The combination of claim 11, wherein cinnamaldehyde and fludioxonil are combined in a ratio of about 1:100 to about 100:1.

13. A composition for preventing or decreasing post-harvest decay or spoilage and improving post-harvest shelf-life of an agricultural produce comprising the combination of claim 11, and at least one agrochemically suitable excipient.

14. The composition of claim 13, wherein the concentration of cinnamaldehyde in the composition ranges from 5%-80% w/w of total composition weight or 0.1%-10% v/v of total composition volume.

15. The composition of claim 13, wherein the concentration of fludioxonil in the composition ranges from 5%-80% w/w of total composition weight or 0.1%-1% v/v of total composition volume.

16. (canceled)

17. A kit-of-parts comprising a first component comprising cinnamaldehyde, a second component comprising fludioxonil, and optionally, a third component comprising one or more agriculturally suitable excipients.
